(19) United States
(12) Patent Application Publication
(10) Pub. No.: US 2022/0363900 A1
(43) Pub. Date: Nov. 17, 2022

(54) MOISTURE-CROSSLINKABLE MASTIC COMPOSITION FOR HIGH-TEMPERATURE JOINT EXPOSURE

(71) Applicant: BOSTIK SA, Colombes (FR)

(72) Inventor: Federico SANZ, VENETTE (FR)

(21) Appl. No.: 17/642,300

(22) PCT Filed: Sep. 17, 2020
(86) PCT No.: PCT/FR2020/051606

§ 371 Date: Mar. 11, 2022

(30) Foreign Application Priority Data
Sep. 19, 2019 (FR) 1910308

(51) Int. Cl. C08L 83/08; C09J 183/08; C09D 183/08

(52) U.S. Cl. CPC C08L 83/08; C09J 183/08; C09D 183/08

(57) ABSTRACT

1) A sealant composition comprising:
from 3% to 80% of a polymer (A) comprising an alkoxysilane group,
at least 25% of a carbonate filler (B), and
from 0.5% to 20% of a polysiloxane resin (C) comprising, as groups directly linked to the silicon atom:
   at least one phenyl group; and
   at least one group chosen from a hydroxyl and an aminoalkylene group; and
from 0.1% to 1% of a crosslinking catalyst (D);

said percentages being expressed by weight on the basis of the total weight of said composition.

2) The use of said composition as adhesive, sealant or coating.

### FIELD OF THE INVENTION

A subject of the present invention is a moisture-crosslinkable sealant composition, more specifically a composition of a silylated sealant, which can be used in particular in the construction field, and which is capable of forming, after crosslinking, an adhesive seal of which the stability after exposure to high temperature is improved.

### TECHNICAL BACKGROUND

Sealants are widely used in the construction field, in particular because of their mechanical properties. They are for example used, by virtue of their deformation-resistance properties, for structural bondings, such as the bonding of concrete elements in civil engineering (such as for the construction of concrete bridges or buildings) or else for the jointing or caulking of the gaps between two construction elements. Sealants also make it possible, by virtue of their elastic properties, to obtain a seal which is stable to dimensional variations induced by various external factors, such as changes in temperature, or else a seal which is sufficiently flexible to deform and adapt to the relative movements of the substrates between which they are applied.

The resistance to deformation of a sealant is, in practice, often represented by the elastic modulus (expressed in Pa). Said modulus is defined, in a tensile test on a sealant test specimen, as being the ratio of the stress that must be applied to said test specimen in order to obtain a given deformation thereof (also referred to as elongation or extension). The elongation is therefore the length to which a test specimen of sealant can extend, expressed as percentage of its initial size. The elastic modulus is often measured for an elongation of 100%.

The elastic properties of a sealant are in general quantified by the elongation at break. The latter (expressed as %) is defined, in a tensile test on a sealant test specimen, as the extension measured for the test specimen at the moment it breaks.

In addition to their mechanical properties, the sealants used in construction are valued for their ability to adhere to an entire variety of substrates and their resistance to meteorological conditions (UV, ozone, water).

An adhesive composition of moisture-crosslinkable sealant, such as a silylated sealant composition, comprises a moisture-crosslinkable prepolymer which has alkoxysilane reactive groups, but are generally end groups. The reaction of these reactive groups with the water originating from the moisture from the air or from the substrate (known as crosslinking reaction) enables, after the use of the sealant, the creation of a solid three-dimensional polymeric network which confers the desired properties, in particular mechanical properties, on the adhesive seal thus created.

International PCT application WO 2018/215463 discloses such a composition, which comprises, in addition to a silylated polymer comprising an alkoxysilane group and a filler, from 0.68% to 1% by weight of a silsesquioxane with a phenyl group and an alkoxy group.

Among the many possible applications of sealants in the construction or industrial fields, there are some for example for which the adhesive seal is located on the outside, in contact with the atmosphere, or else under a glass wall. Such seals are thus liable to be exposed, for long periods of time, to high temperatures under the effect of solar radiation and, because of the climate specific to hot countries, typically temperatures that can range up to 90° C. For yet other industrial applications, adhesive seals can be frequently exposed to temperatures that are even higher, possibly ranging up to 140° C.

There is thus a need for such adhesive seals to maintain their advantageous mechanical properties, in particular of deformation resistance and of elasticity, for the duration.

The aim of the present invention is therefore to provide a sealant composition comprising a polymer comprising an alkoxysilane group, which allows, after crosslinking, the formation of an adhesive seal which exhibits improved stability when it is exposed to high temperatures.

Another aim of the present invention is to provide a sealant composition comprising a copolymer comprising an alkoxysilane group which makes it possible, after crosslinking and after exposure of the adhesive seal to a high temperature over a long period of time, to maintain the deformation resistance properties and the elasticity properties at a level that is acceptable in practice, in particular its elongation at break and its elastic modulus.

### DESCRIPTION OF THE INVENTION

The invention thus relates to a sealant composition comprising:
from 3% to 80% of a polymer (A) comprising an alkoxysilane group,
at least 25% of a carbonate filler (B), and
from 0.5% to 20% of a polysiloxane resin (C) comprising, as groups directly linked to the silicon atom:
   at least one phenyl group; and
   at least one group chosen from a hydroxyl and an aminoalkylene group of formula: —R′⁰—NH—R″⁰; wherein:
      R′⁰ is an alkylene radical comprising from 2 to 5 carbon atoms; and
      R″⁰ is a hydrogen atom or an alkyl radical comprising from 1 to 5 carbon atoms; and
from 0.1% to 1% of a crosslinking catalyst (D);

said percentages being expressed by weight on the basis of the total weight of said composition.

It has in fact been found that this sealant composition which is the subject of the invention makes it possible to obtain, after crosslinking, an adhesive seal which has better retention of its properties of deformation resistance and of elasticity, in particular of elastic modulus and of elongation at break, after having been exposed for one week to temperatures of between 80 and 150° C. These elasticity properties are in particular, surprisingly, significantly improved compared to those of the sealant composition which is the subject of WO 2018/215463 mentioned above.

Polymer (A) Comprising an Alkoxysilane Group:

The sealant composition according to the invention comprises from 3% to 80% by weight of a polymer comprising an alkoxysilane group, on the basis of the total weight of said composition.

The polymer comprising an alkoxysilane group is a polymer which comprises at least one, preferably at least two, groups of formula (I):

[Chem 1]

—Si(R⁴)ₚ(OR⁵)₃₋ₚ (I)
wherein:
R⁴ and R⁵, which may be identical or different, each represent a linear or branched alkyl radical comprising from 1 to 4 carbon atoms; and
p is an integer equal to 0, 1 or 2;
and, preferably:
R⁴ and R⁵ each represent a methyl radical; and
p is equal to 0 or 1.

Preferably, the group(s) of formula (I) are groups located at the ends of the main chain of the polymer, also known as end groups.

Preferably, the main chain of the polymer comprising at least one alkoxysilane group is chosen from polyurethanes, polyethers and mixtures thereof.

The polymer comprising at least one alkoxysilane group can exhibit a number-average molecular weight ranging from 500 to 50 000 g/mol, more preferably ranging from 700 to 20 000 g/mol. The number-average molecular weight of the polymers can be measured by methods well known to a person skilled in the art, for example by size exclusion chromatography using standards of polyethylene glycol type.

According to one embodiment, the polymer (A) comprising at least one alkoxysilane group is chosen from the polymers of formulae (II), (Ill) or (IV) as defined below, and mixtures thereof:

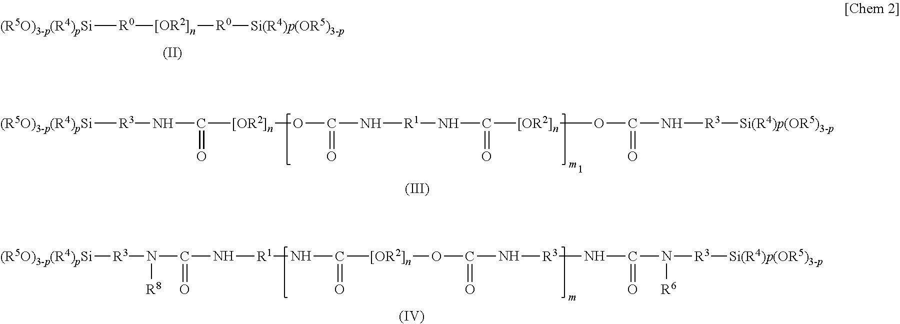

wherein:
R⁰ represents a linear or branched divalent alkylene radical comprising from 3 to 6 carbon atoms;
R¹ represents a divalent hydrocarbon-based radical comprising from 5 to 15 carbon atoms which can be aromatic or aliphatic and linear, branched or cyclic;
R² represents a linear or branched divalent alkylene radical comprising from 2 to 4 carbon atoms;
R³ represents a linear or branched divalent alkylene radical comprising from 1 to 6 carbon atoms, R³ preferably representing methylene or n-propylene radicals;
R⁴ and R⁵ are as defined above;
R⁶ represents a hydrogen atom, a phenyl radical, a linear, branched or cyclic alkyl radical comprising from 1 to 6 carbon atoms, or a 2-succinate radical of formula:

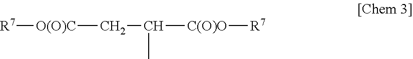

wherein R⁷ is a linear or branched alkyl radical comprising from 1 to 6 carbon atoms;
n is an integer such that the number-average molecular weight of the polyether block of formula —[OR²]ₙ— ranges from 300 g/mol to 40 000 g/mol in the polymers of formulae (II), (Ill) and (IV);
m₁ is zero or an integer;
n and m₁ are such that the number-average molecular weight of the polymer of formula (III) ranges from 500 g/mol to 50 000 g/mol, preferably from 700 g/mol to 20 000 g/mol;
m is an integer other than zero;
n and m are such that the number-average molecular weight of the polymer of formula (IV) ranges from 500 g/mol to 50 000 g/mol, preferably from 700 g/mol to 20 000 g/mol;
p is as defined above.

Preferably, the R¹ radical of formulae (Ill) and (IV) is chosen from one of the following divalent radicals, the formulae of which below show the two free valencies:
a) the divalent radical derived from isophorone diisocyanate (IPDI):

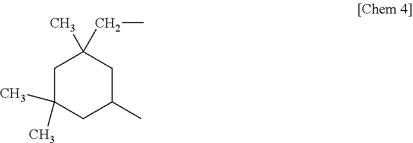

b) the divalent radical derived from 4,4′- and 2,4′-dicyclohexylmethane diisocyanate (HMDI):

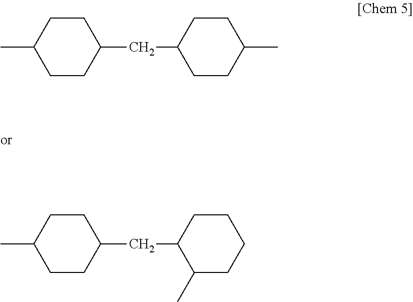

c) the radical derived from 2,4- and 2,6-toluene diisocyanate (TDI):

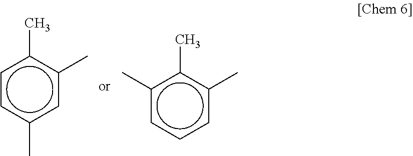

d) the radical derived from 4,4′- and 2,4′-diphenylmethane diisocyanate (MDI):

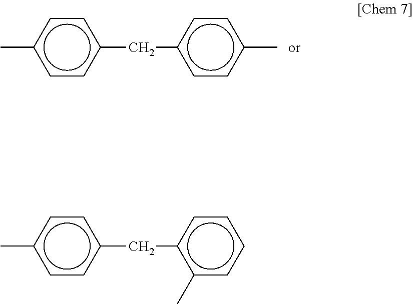

e) the radical derived from m-xylylene diisocyanate (m-XDI):

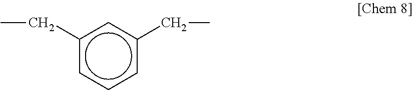

f) the radical derived from hexamethylene diisocyanate (HDI):

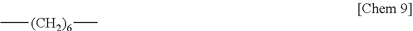

Preferably, the R¹ radical of formulae (Ill) and (IV) is the divalent radical derived from isophorone diisocyanate or from xylylene diisocyanate.

The polymers of formula (II) can be obtained by hydrosilylation of polyether diallyl ether according to a process described, for example, in document EP 1 829 928.

Among the polymers corresponding to formula (II), mention may be made of:
MS Polymer™ S303H (available from Kaneka), corresponding to a polyether comprising two groups of formula (I) of dimethoxy type (p is equal to 1 and R⁴ represents a methyl group) having a number-average molecular weight of approximately 22000 g/mol and a viscosity of 12.5 Pa·s at 23° C.;
MS Polymer™ S227 (available from Kaneka) corresponding to a polyether comprising two groups of formula (I) of dimethoxy type (p is equal to 1 and R⁵ and R⁴ each represent a methyl group) having a number-average molecular weight of about 27000 g/mol and a viscosity of 34 Pa·s at 23° C.

The polymers of formula (III) can be obtained according to a process described in documents EP 2 336 208 and WO 2009/106699.

Mention may be made, among the polymers corresponding to the formula (III), for example, of:
Geniosil® STP-E10 (available from Wacker): polyether comprising two groups (1) of dimethoxy type (m₁ equal to 0, p equal to 1 and R⁴ and R⁵ represent a methyl group) having a number-average molecular weight of about 8889 g/mol where R³ represents a methylene group;
Geniosil® STP-E30 (available from Wacker): polyether comprising two groups of formula (I) of dimethoxy type (m₁ equal to 0, p equal to 1 and R⁴ and R⁵ represent a methyl group) having a number-average molecular weight of about 14493 g/mol where R³ represents a methylene group;
Geniosil® STP-E35 (available from Wacker): polyether comprising two groups of formula (I) of trimethoxy type (m₁ equal to 0, p equal to 0 and R⁵ represents a methyl group), having a number-average molecular weight of approximately 32240 g/mol wherein R³ represents an n-propylene group, and having a viscosity of approximately 30000 mPa·s at 23° C.;
SPUR+® 1050MM (available from Momentive): polyether polyurethane comprising two groups of formula (I) of trimethoxy type (m₁ other than 0, p equal to 0 and R⁵ represents a methyl group) exhibiting a number-average molecular weight of approximately 21000 g/mol where R³ represents an n-propylene group;
SPUR+® Y-19116 (available from Momentive): polyurethane comprising two groups of formula (I) of trimethoxy type (m₁ other than 0 and R⁵ represents a methyl group) exhibiting a number-average molecular weight ranging from 15000 to 17000 g/mol where R³ represents an n-propylene group;
Desmoseal® S XP 2636 (available from Bayer): polyurethane comprising two groups of formula (I) of trimethoxy type (m₁ other than 0, p equal to 0 and R⁵ represents a methyl group) exhibiting a number-average molecular weight of approximately 15038 g/mol where R³ represents an n-propylene group.

The polymers of formula (IV) can be obtained according to the process comprising:
a) reaction of a polyether polyol of following formula:

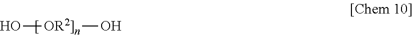

with a stoichiometric excess of diisocyanate having the following formula: NCO—R¹—NCO in order to form a polyurethane-polyether block having at least two —NCO end groups, said block preferably comprising from 1.5% to 1.9% by weight of —NCO groups, then
   b) reaction between a block obtained in the preceding step with a stoichiometric amount or a slight excess of an α-, β- or γ-aminosilane having the following formula:

[Chem 11]

(R⁵O)₃₋ₚ(R⁴)ₚ|Si-R³—NH—R⁶

Such a process is described, for example, in WO 2013/136108.

Among the polymers corresponding to formula (IV), mention may be made of SPUR+1015 LM (available from Momentive), corresponding to a polyether polyurethane comprising two groups of formula (I) of trimethoxy type (p is equal to 0 and R⁵ represents a methyl group) having a number-average molecular weight of approximately 25000 g/mol and a viscosity of 50 Pa·s at 23° C.

The composition according to the invention can comprise a polymer of formula (II) or a mixture of different polymers of formula (II).

It may also comprise a polymer of formula (III) or a mixture of different polymers of formula (III).

It may also comprise a polymer of formula (IV) or a mixture of different polymers of formula (IV).

According to one preferred embodiment, the composition according to the invention comprises a polymer of formula (II) and a polymer of formula (III).

According to one embodiment, the composition according to the invention comprises from 5% to 60% by weight, preferentially from 5% to 50% by weight, advantageously from 10% to 50% by weight, for example from 10% to 40% by weight, advantageously from 20% to 30%, in particular from 22% to 24%, by weight, of at least one polymer comprising an alkoxysilane group, relative to the total weight of said composition.

Carbonate Filler (B):

The sealant composition according to the invention comprises at least 25% by weight of a carbonate filler, on the basis of the total weight of said composition.

According to one embodiment, the carbonate filler is chosen from alkali metal or alkaline-earth metal carbonates and mixtures thereof; preferably, the carbonate filler is calcium carbonate.

The calcium carbonate can be rendered hydrophobic, for example with calcium stearate or an analog, making it possible to confer a partial or complete hydrophobicity on the calcium carbonate particles. The more or less hydrophobic character of the calcium carbonate can have an impact on the rheology of the composition. Moreover, the hydrophobic coating can make it possible to prevent the calcium carbonate from absorbing the constituents of the composition and from rendering them ineffective. The hydrophobic coating of the calcium carbonate can represent from 0.1% to 3.5% by weight, with respect to the total weight of calcium carbonate.

The calcium carbonate which can be used in the present invention preferably has a particle size ranging from 0.1 to 400 μm, more preferably from 1 to 400 μm, preferentially from 10 to 350 μm, more preferably from 50 to 300 μm.

Mention may be made, by way of example of calcium carbonate, of Mikhart® 1T (available from La Provençale).

According to one preferred variant, the composition according to the invention can comprise from 25% to 80% by weight, preferentially from 40% to 60% by weight, in particular from 45% to 55% by weight, of the carbonate filler, relative to the total weight of the composition.

Polysiloxane Resin (C):

The sealant composition according to the invention comprises from 0.5% to 20% of a polysiloxane resin (C) comprising, as groups directly linked to the silicon atom:
at least one phenyl group; and
at least one group chosen from a hydroxyl and an aminoalkylene group of formula:—R′⁰—NH—R″⁰; wherein
   R′⁰ is an alkylene radical comprising from 2 to 5 carbon atoms; and
   R″⁰ is a hydrogen atom or an alkyl radical comprising from 1 to 5 carbon atoms.

The polysiloxane resins are polymer or oligomer resins, the repeating unit of which is derived from a siloxane compound of formula: R′R″SiO wherein R′ and R″ are organic or mineral substituents directly linked to the silicon atom.

Said repeating unit may be included, in order to constitute a polysiloxane resin, in a linear chain, in a two-dimensional structure or in a three-dimensional structure, such as a silsesquioxane.

According to one embodiment, the polysiloxane resin (C) is a silsesquioxane.

Silsesquioxanes are polysiloxanes which can adopt a polyhedral structure or a polymeric structure, with Si—O—Si bonds. They typically have the following general structure:

[RSiO_{3/2}]ₜ
wherein R represents an organic radical and t is an integer which may range from 6 to 12, t preferably being equal to 6, 8, 10 or 12.

According to one preferred embodiment, the polysiloxane resin (C) is a silsesquioxane having a polyhedral structure (or POSS for “Polyhedral Oligomeric Silsesquioxane”).

Even more preferably, the silsesquioxane (C) corresponds to general formula (V) below:

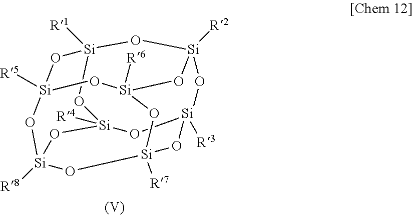

wherein each one from among R′¹ to R′⁸ represents, independently of one another, a group chosen from:
   a hydrogen atom,
   a hydroxyl group or an aminoalkylene group of formula: —R′⁰—NH—R″⁰; wherein R′⁰ and R″⁰ are as defined above;
   a radical chosen from the group consisting of a linear or branched C₁-C₄ alkoxy radical, a linear or branched alkyl radical comprising from 1 to 30 carbon atoms, an alkenyl radical comprising from 2 to 30 carbon atoms, an aromatic radical comprising from 6 to 30 carbon atoms, an allyl radical comprising from 3 to 30 carbon atoms, a cyclic aliphatic radical comprising from 3 to 30 carbon atoms and an acyl radical comprising from 1 to 30 carbon atoms, and
   an —OSiR′⁹R′¹⁰ group wherein R′⁹ and R′¹⁰ each represent, independently of one another, a hydrogen atom or a radical chosen from the group consisting of a linear or branched C₁-C₄ alkyl, a linear or branched C₁-C₄ alkoxy, a C₂-C₄ alkenyl, a phenyl, a C₃-C₆ allyl radical, a cyclic C₃-C₅ aliphatic radical and a C₁-C₄ acyl radical;
on condition that:
   at least one radical among the R′¹ to R′⁸ radicals is a phenyl radical; and
   at least one radical among the R′¹ to R′⁸ radicals is either a hydroxyl group or an aminoalkylene group of formula: —R′⁰—NH—R″⁰; wherein R′⁰ and R″⁰ are as defined above.

Preferably, in the abovementioned formula (V), each of R′¹ to R′⁸ represents, independently of one another, a group chosen from:
a hydrogen atom,
a hydroxyl group or an aminoalkylene group of formula: —R′⁰—NH—R″⁰; wherein R′⁰ and R″⁰ are as defined above;
a radical chosen from the group consisting of a linear or branched C₁-C₄ alkoxy radical, a linear or branched alkyl radical comprising from 1 to 12 carbon atoms, preferentially from 1 to 8 carbon atoms and, for example, from 1 to 5 carbon atoms, and an aromatic radical comprising from 6 to 12 carbon atoms, and
an —OSiR′⁹R′¹⁰ group wherein R′⁹ and R′¹⁰ each represent, independently of one another, a hydrogen atom or a radical chosen from a linear or branched C₁-C₄ alkyl, for example methyl or ethyl, preferably methyl,
on condition that:
   at least one radical among the R′¹ to R′⁸ radicals is a phenyl radical; and
   at least one radical among the R′¹ to R′⁸ radicals is either a hydroxyl group or an aminoalkylene group of formula: —R′⁰—NH—R″⁰; wherein R′⁰ and R″⁰ are as defined above.

According to one embodiment, the polysiloxane resin (C) comprises, as group directly linked to the silicon atom, at least one hydroxyl group. The content of corresponding Si—OH units in the polysiloxane resin (C) is generally between 4% and 8% by weight of said units, on the basis of the weight of (C).

According to another embodiment, the polysiloxane resin (C) comprises, as group directly linked to the silicon atom, at least one aminoalkylene group of formula: —R′⁰—NH—R″₀, wherein:
R′⁰ is an alkylene radical comprising from 2 to 5 carbon atoms; and
R″⁰ is a hydrogen atom or an alkyl radical comprising from 1 to 5 carbon atoms.

According to an even more preferred variant, R′⁰ is an alkylene radical comprising from 2 to 3 carbon atoms and R″⁰ is a hydrogen atom.

The content of corresponding Si—R′⁰—NH—R″⁰ units in the polysiloxane resin (C) is generally such that the weight of resin (C) per mole of NH is between 200 and 300 g.

According to yet another embodiment, the polysiloxane resin (C), in particular when it is a silsesquioxane (C), preferably of formula (V), has a number-average molecular weight ranging from 400 g/mol to 4000 g/mol, preferentially from 500 g/mol to 2500 g/mol.

The number-average molecular weights of the polysiloxane resins, in particular of the silsesquioxanes, can be measured by methods well known to a person skilled in the art, for example by size exclusion chromatography using polystyrene-type standards.

By way of example of polysiloxane (C), mention may be made of the following two products available from Dow Corning:
Dowsil® 3055 (CAS number: 1242619-23-3) is a silsesquioxane, the number-average molecular weight of which is between 500 and 1000 g/mol, and which comprises at least one phenyl group and at least one aminopropyl group which are directly linked to the silicon atom; the content of Si-aminopropyl units being such that the weight of said silsesquioxane per mole of NH is between 250 and 270 g;
Dowsil® RSN-0217 (CAS number: 63148-53-8) is a polysiloxane, the number-average molecular weight of which is between 1500 and 2500 g/mol, and which comprises at least one phenyl group and at least one hydroxyl group which are directly linked to the silicon atom; the content of corresponding Si—OH units in said polysiloxane being 6% by weight of said units, on the basis of the weight of said polysiloxane.

According to one preferred variant, the composition according to the invention can comprise from 0.5% to 10%, preferentially from 0.5% to 5%, in particular from 0.5% to 1.5% by weight, of the polysiloxane resin (C), relative to the total weight of composition.

Crosslinking Catalyst (D):

The sealant composition according to the invention comprises from 0.1% to 1% of a crosslinking catalyst (D), on the basis of the total weight of said composition.

The catalyst (D) can be any catalyst known to a person skilled in the art for the condensation of silanol. Mention may be made, as examples of such catalysts, of:
aminosilanes, such as 3-(N-(2-aminoethyl)amino)propyltrimethoxysilane (commercially available under the name Silquest® A-1120 from Momentive) or 3-aminopropyltrimethoxysilane,
organotitanium derivatives, such as titanium acetylacetonate (commercially available under the name Tyzor® AA75 from DuPont de Nemours),
aluminum, such as aluminum chelate (commercially available under the name K-KAT® 5218 from King Industries),
amines, such as 1,8-diazabicyclo[5.4.0]undec-7-ene (DBU) or 1,5-diazabicyclo[4.3.0]non-5-ene (DBN), 2,2′-dimorpholinodiethyl ether (DMDEE) or 1,4-diazabicylo[2.2.2]octane (DABCO),
tin-based catalysts, such as, for example, Neostann® S-1 or TIB-KAT® 216 (respectively available from Kaneka or TIB Chemicals). These tin-based catalysts are particularly suitable for silylated polymers of formula (II).

The catalyst(s) preferably represent from 0.2% to 0.8% by weight, relative to the total weight of the composition.

Other Additives:

According to one embodiment, the composition comprises, in addition to the ingredients (A), (B), (C) and (D), from 0% to 30% by weight, in particular from 0.5% to 30% by weight, preferably from 10% to 30% by weight, of at least one additive chosen from plasticizers, solvents, pigments, adhesion promoters, moisture absorbers, UV stabilizers (or antioxidants), rheological agents, and also fillers other than carbonate fillers.

The composition according to the invention can in particular comprise at least one plasticizing agent in a proportion of 5% to 30% by weight, preferably of 10% to 30% by weight, preferentially of 15% to 25% by weight, with respect to the total weight of said composition.

Use may be made, by way of example of plasticizing agent which can be used, of any plasticizing agent generally used in the field of sealant compositions.

Preferably, use is made of:
diisodecyl phthalate, as sold under the name Palatinol™ DIDP by BASF,
an alkylsulfonic acid ester of phenol, as sold under the name Mesamoll® by Lanxess,
diisononyl 1,2-cyclohexanedicarboxylate, as sold under the name Hexamoll Dinch® by BASF,
pentaerythritol tetravalerate, as sold under the name Pevalen™ by Perstorp.

The composition according to the invention may also comprise from 0% to 5% by weight of a solvent, preferably a solvent that is volatile at ambient temperature (temperature of about 23° C.). The volatile solvent may, for example, be chosen from alcohols which are volatile at ambient temperature, such as ethanol or isopropanol. The volatile solvent makes it possible, for example, to reduce the viscosity of the composition and make the composition easier to apply. The volatile character of the solvent makes it possible for the seal, obtained after curing the composition, to no longer contain solvent. Thus, the solvent has, for example, no negative influence on the hardness of the seal.

The composition according to the invention may also comprise up to 3% by weight of a pigment chosen from organic or inorganic pigments.

For example, the pigment may be TiO₂, in particular Kronos® 2059 sold by Kronos.

The composition according to the invention may also comprise up to 3% by weight of an adhesion promoter which can be for example an aminosilane, such as 3-aminopropyltrimethoxysilane (also known as AMMO).

The composition according to the invention may also comprise up to 3% by weight of a moisture absorber which can be chosen from vinyltrimethoxysilane (VTMO), vinyltriethoxysilane (VTEO) or alkoxyarylsilanes, such as Geniosil® XL 70 available from Wacker.

The composition according to the invention may also comprise UV stabilizers or antioxidants, among which mention may be made of benzotriazoles, benzophenones, “hindered” amines, such as bis(2,2,6,6-tetramethyl-4-piperidyl) sebacate, and mixtures thereof. Mention may be made, for example, of the products Tinuvin® 328 or Tinuvin™ 770, sold by BASF.

The composition according to the invention may also comprise from 1% to 30% by weight (relative to the total weight of the composition according to the invention) of a rheological agent, preferably from 5% to 30% by weight, more preferentially from 10% to 25% by weight.

Mention may be made, by way of example of a rheological agent, of any rheological agent normally used in the field of sealant compositions.

Preferably, use is made of one or more rheological agents chosen from thixotropic agents, and more preferably from:
PVC plastisols, corresponding to a suspension of PVC in a plasticizing agent which is miscible with PVC, obtained in situ by heating to temperatures ranging from 60° C. to 80° C. These plastisols can be those described in particular in the publication Polyurethane Sealants, Robert M. Evans, ISBN 087762-998-6,
fumed silica,
urea derivatives resulting from the reaction of an aromatic diisocyanate monomer, such as 4,4′-MDI, with an aliphatic amine, such as butylamine. The preparation of such urea derivatives is described in particular in the application FR 1 591 172;
micronized amide waxes, such as Crayvallac SLX sold by ARKEMA.

The composition according to the invention may finally comprise from 0% to 30% by weight, preferably from 0% to 10%, even more preferentially from 1% to 10% by weight (relative to the total weight of the composition) of a filler other than the carbonate filler (D) defined above.

Said filler other than the carbonate filler (D) can be chosen from organic fillers, inorganic fillers and mixtures thereof.

Use may be made, as organic filler(s), of any organic filler(s) and in particular polymeric filler(s) typically used in the field of sealant compositions.

Use may be made, for example, of polyvinyl chloride (PVC), polyolefins, rubber, ethylene/vinyl acetate (EVA) or aramid fibers, such as Kevlar®.

Use may also be made of hollow microspheres made of expandable or non-expandable thermoplastic polymer. Mention may notably be made of hollow microspheres made of vinylidene chloride/acrylonitrile.

The mean particle size of the filler(s) which can be used as filler other than the carbonate filler (D) is preferably less than or equal to 10 microns, more preferentially less than or equal to 3 microns, in order to prevent them from settling in the composition according to the invention during its storage.

The mean particle size is measured for a volume particle size distribution corresponding to 50% by volume of the sample of particles which is analyzed. When the particles are spherical, the mean particle size corresponds to the median diameter (D50 or Dv50), which corresponds to the diameter such that 50% of the particles by volume have a size which is smaller than said diameter. In the present application, this value is expressed in micrometers and determined according to the standard NF ISO 13320-1 (1999) by laser diffraction on an appliance of Malvern type.

Preferably, the filler other than the carbonate filler (D) is an inorganic filler.

The inorganic fillers can be provided in the form of particles of diverse geometry. They can, for example, be spherical or fibrous or exhibit an irregular shape.

According to one embodiment, the filler is chosen from sand, glass beads, glass, quartz, barite, alumina, mica or talc. Preferably, the filler other than the carbonate filler (D) is chosen from sand and glass beads.

The sand which can be used in the present invention preferably has a particle size ranging from 0.1 to 400 μm, preferentially from 1 to 400 μm, more preferably from 10 to 350 μm, more preferably from 50 to 300 μm.

The glass beads which can be used in the present invention preferably have a particle size ranging from 0.1 to 400 μm, preferentially from 1 to 400 μm, more preferably from 10 to 350 μm, more preferably from 50 to 300 μm.

According to one preferred variant, the composition according to the invention comprises, and preferably essentially consists of:
10% to 50% by weight of polymer (A) comprising an alkoxysilane group;
25% to 80% by weight of carbonate filler (B);
0.5% to 5% by weight of polysiloxane resin (C);
0.2% to 0.8% by weight of crosslinking catalyst (D); and
0.5% to 30% of an additive chosen from plasticizers, solvents, pigments, adhesion promoters, moisture absorbers, UV stabilizers, rheological agents and also fillers other than the carbonate fillers.

According to another preferred variant, the composition according to the invention comprises, and preferably essentially consists of:
20% to 30% by weight of polymer (A) comprising an alkoxysilane group;
40% to 60% by weight of carbonate filler (B);
0.5% to 1.5% by weight of polysiloxane resin (C);
0.2% to 0.8% by weight of crosslinking catalyst (D); and
10% to 30% of an additive chosen from plasticizers, solvents, pigments, adhesion promoters, moisture absorbers, UV stabilizers, rheological agents and also fillers other than the carbonate fillers.

The composition which is the subject of the invention can be prepared by simply mixing its ingredients. Preferably, the polymer(s) comprising an alkoxysilane group (A) are mixed with the polysiloxane resin (C) in a suitable container, then with the filler(s) (carbonate filler (B) and other fillers) at a temperature ranging from 5° C. to 80° C., preferably under an inert atmosphere. The moisture absorber, followed by the other additives and, finally, the catalyst (D) are subsequently introduced into the mixer.

The present invention also relates to the use of the composition as defined above as adhesive, sealant or coating, preferably as sealant, for example as construction sealant.

The substrates involved are very varied, and preferably chosen from concrete, a metal such as aluminum, or else steel.

The composition can in particular be used in the construction field to form for example sealing and expansion joints in buildings, in particular between concrete/concrete substrates. The composition may also be used in industry, for example in the automobile industry, for assembling equipment such as, for example, tunnel furnaces used for painting cars.

The examples that follow are given purely by way of illustration of the invention and should not be interpreted in order to limit the scope thereof.

### EXAMPLES

### Example A (Reference)

The sealant composition listed in table 1 below was prepared by mixing the ingredients according to the procedure indicated above. The content of ingredient is indicated as % weight/weight.

Measurement of the Elongation at Break of the Adhesive Seal (Obtained at Initial Time):

The principle of the measurement consists in drawing, in a tensile testing device, the movable jaw of which moves at a constant rate equal to 100 mm/minute, a standard test specimen consisting of the crosslinked composition (constituting the adhesive seal) and in recording, at the moment when the test specimen breaks, the tensile stress applied (in MPa) and also the elongation of the test specimen (as %).

The standard test specimen is dumbbell-shaped, as illustrated in the international standard ISO 37. The narrow part of the dumbbell used has a length of 20 mm, a width of 4 mm and a thickness of 500 μm.

In order to prepare said test specimen, the sealant composition is applied in a Teflon mold, and left to crosslink for 15 days at 23° C. and 50% relative humidity.

The measurement is carried out immediately after crosslinking.

The result obtained is given as % in table 2.

Measurement of the Modulus at 100% Elongation of the Adhesive Seal (Obtained at Initial Time):

The tensile test described above is repeated with the same tensile testing device and the same standard test specimen, obtained by crosslinking the sealant composition under the same conditions.

The modulus at 100% elongation obtained is indicated in MPa in table 2.

Measurement of the Elongation at Break and of the Modulus at 100% Elongation after Storage at Temperature of the Adhesive Seal:

The above measurements are repeated on a sealant composition which, after crosslinking, is exposed to a temperature of 130° C. for 1 week.

The results obtained are shown in table 2.

### Examples 1 and 2 (According to the Invention)

Example A is repeated with the compositions of examples 1 and 2 listed in table 1.

The results obtained, shown in table 2, clearly reveal that the elongation at break of the adhesive seal of examples 1 and 2 which was stored for 1 week at 130° C. is significantly better maintained relative to that measured immediately after crosslinking, compared to the reference composition A. The same is true for the modulus at 100% elongation.

More particularly, the values measured after storage of the adhesive seal for one week at 130° C., for the elongation at break and the modulus at 100% elongation, are acceptable for examples 1 and 2 whereas they are not acceptable for the reference example A.

### Example B (Comparative)

Example A is repeated with the composition of example B listed in table 1, which is in accordance with the teaching of international application WO 2018/215463.

The result obtained, given in table 2, shows a significant degradation of the adhesive seal, both for the elongation at break and for the modulus at 100% elongation, which degradation results from the storage of said adhesive seal for one week at 130° C., compared to the compositions of examples 1 and 2.

More particularly, the values measured after storage of the adhesive seal for one week at 130° C., for the elongation at break and the modulus at 100% elongation, are not acceptable.

TABLE 1

| | | Content (as % weight/weight) | | | |
|---|---|---|---|---|---|
| | | Ex. A | | | Ex. B |
| | Ingredients | (ref.) | Ex. 1 | Ex. 2 | (comp.) |
| (A) | Geniosil ® STP-E35 | 15.97 | 15.00 | 15.00 | 15.00 |
| | MS Polymer ™ S227 | 7.00 | 7.00 | 7.00 | 7.00 |
| (B) | Mikhart ® 1T | 49.70 | 49.70 | 49.70 | 49.70 |
| (C) | Dowsil ® 3055 | — | 0.97 | — | — |
| | Dowsil ® 0217 | — | — | 0.97 | — |
| | DC 3074 ® | — | — | — | 0.97 |
| (D) | Silquest ® A-1120 | 0.49 | 0.49 | 0.49 | 0.49 |
| | DBU | 0.10 | 0.10 | 0.10 | 0.10 |
| | Mesamoll ® | 19.28 | 19.28 | 19.28 | 19.28 |
| | Kronos ® 2059 | 1.98 | 1.98 | 1.98 | 1.98 |
| | VTMO | 1.48 | 1.48 | 1.48 | 1.48 |
| | Tinuvin ® T770 | 0.25 | 0.25 | 0.25 | 0.25 |
| | Tinuvin ® 328 | 0.25 | 0.25 | 0.25 | 0.25 |
| | Crayvallac SLX | 3.50 | 3.50 | 3.50 | 3.50 |

TABLE 2

| Property measured for | | Ex. A | | | Ex. B |
|---|---|---|---|---|---|
| the adhesive seal | | (ref.) | Ex. 1 | Ex. 2 | (comp.) |
| Immediately | Elongation at break | 580 | 740 | 650 | 630 |
| after | (as %) | | | | |
| crosslinking | Modulus at 100% | 0.75 | 0.5 | 0.57 | 0.55 |
| | elongation (in MPa) | | | | |
| after | Elongation at break | 20 | 400 | 210 | 65 |
| storage for | (as %) | | | | |
| one week | Modulus at 100% | 0 | 0.48 | 0.4 | 0.15 |
| at 130° C. | elongation (in MPa) | | | | |

1-12. (canceled)

13. A sealant composition comprising:
from 3% to 80% of a polymer (A) comprising an alkoxysilane group,
at least 25% of a carbonate filler (B), and
from 0.5% to 20% of a polysiloxane resin (C) comprising, as groups directly linked to the silicon atom:
at least one phenyl group; and
at least one group chosen from the group consisting of a hydroxyl and an aminoalkylene group of formula: —R′⁰—NH—R″⁰, wherein:
R′⁰ is an alkylene radical comprising from 2 to 5 carbon atoms; and
R″⁰ is a hydrogen atom or an alkyl radical comprising from 1 to 5 carbon atoms; and
from 0.1% to 1% of a crosslinking catalyst (D);
said percentages being expressed by weight on the basis of the total weight of said composition.

14. The sealant composition as claimed in claim 13, wherein the polymer (A) comprising an alkoxysilane group comprises at least one group of formula (I):
[Chem 13]
—Si(R⁴)ₚ(OR⁵)₃₋ₚ (I)
wherein:
R⁴ and R⁵, which may be identical or different, each represent a linear or branched alkyl radical comprising from 1 to 4 carbon atoms; and
p is an integer equal to 0, 1 or 2.

15. The sealant composition as claimed in claim 14, wherein the polymer (A) comprising an alkoxysilane group is selected from the group consisting of the polymers of formulae (II), (III) and (IV): 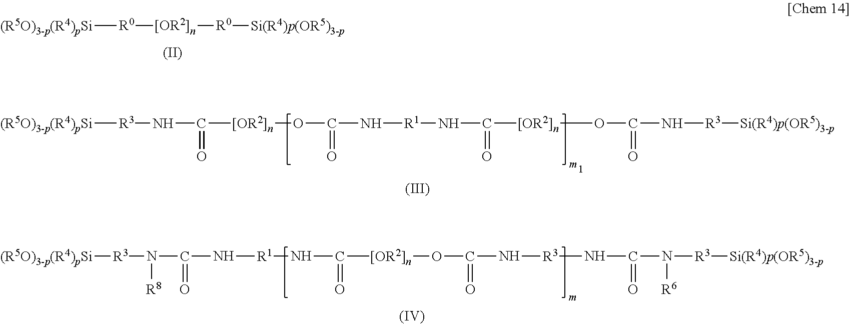
wherein:
R⁰ represents a linear or branched divalent alkylene radical comprising from 3 to 6 carbon atoms;
R¹ represents a divalent hydrocarbon-based radical comprising from 5 to 15 carbon atoms which can be aromatic or aliphatic and linear, branched or cyclic;
R² represents a linear or branched divalent alkylene radical comprising from 2 to 4 carbon atoms;
R³ represents a linear or branched divalent alkylene radical comprising from 1 to 6 carbon atoms;
R⁶ represents a hydrogen atom, a phenyl radical, a linear, branched or cyclic alkyl radical comprising from 1 to 6 carbon atoms, or a 2-succinate radical of formula: 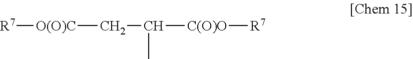
wherein R⁷ is a linear or branched alkyl radical comprising from 1 to 6 carbon atoms;
n is an integer such that the number-average molecular weight of the polyether block of formula —[OR²]ₙ— ranges from 300 g/mol to 40 000 g/mol in the polymers of formulae (II), (Ill) and (IV);
m₁ is zero or an integer;
n and m₁ are such that the number-average molecular weight of the polymer of formula (III) ranges from 500 g/mol to 50 000 g/mol;
m is an integer other than zero; and
n and m are such that the number-average molecular weight of the polymer of formula (IV) ranges from 500 g/mol to 50 000 g/mol.

16. The sealant composition as claimed in claim 13, wherein the carbonate filler is selected from the group consisting of alkali metal and alkaline-earth metal carbonates and mixtures thereof.

17. The sealant composition as claimed in claim 13, wherein the polysiloxane resin (C) comprises an aminoalkylene group of formula:
R′⁰—NH—R″⁰; wherein R′⁰ is an alkylene radical comprising from 2 to 3 carbon atoms and R″⁰ is a hydrogen atom.

18. The sealant composition as claimed in claim 13, wherein the polysiloxane resin (C) is a silsesquioxane.

19. The sealant composition as claimed in claim 18, wherein the silsesquioxane (C) corresponds to general formula (V): 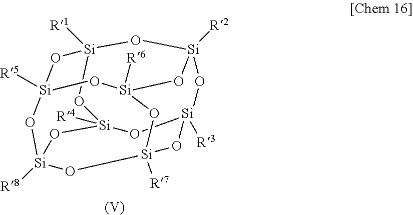
wherein each one from among R′¹ to R′⁸ represents, independently of one another, a group chosen from:
a hydrogen atom,
a hydroxyl group or the aminoalkylene group of formula: —R′⁰—NH—R″⁰;
a radical chosen from the group consisting of a linear or branched C₁-C₄ alkoxy radical, a linear or branched alkyl radical comprising from 1 to 30 carbon atoms, an alkenyl radical comprising from 2 to 30 carbon atoms, an aromatic radical comprising from 6 to 30 carbon atoms, an allyl radical comprising from 3 to 30 carbon atoms, a cyclic aliphatic radical comprising from 3 to 30 carbon atoms and an acyl radical comprising from 1 to 30 carbon atoms, and
an —OSiR′⁹R′¹⁰ group wherein R′⁹ and R′¹⁰ each represent, independently of one other, a hydrogen atom or a radical chosen from the group consisting of a linear or branched C₁-C₄ alkyl, a linear or branched C₁-C₄ alkoxy, a C₂-C₄ alkenyl, a phenyl, a C₃-C₆ allyl radical, a cyclic C₃-C₈ aliphatic radical and a C₁-C₄ acyl radical;
on condition that:
at least one radical among the R′¹ to R′⁸ radicals is a phenyl radical; and
at least one radical among the R′¹ to R′⁸ radicals is either a hydroxyl group or the aminoalkylene group of formula: —R′⁰—NH—R″⁰—.

20. The sealant composition as claimed in claim 13, wherein the polysiloxane resin (C) has a number-average molecular weight ranging from 400 g/mol to 4000 g/mol.

21. The sealant composition as claimed in claim 13, further comprising, in addition to the ingredients (A), (B), (C) and (D), from 0.5% to 30% by weight of at least one additive selected from the group consisting of plasticizers, solvents, pigments, adhesion promoters, moisture absorbers, UV stabilizers, rheological agents, and also fillers other than the carbonate fillers.

22. The sealant composition as claimed in claim 13, wherein the sealant comprises from:
10% to 50% by weight of polymer (A) comprising an alkoxysilane group;
25% to 80% by weight of carbonate filler (B);
0.5% to 5% by weight of polysiloxane resin (C);
0.2% to 0.8% by weight of crosslinking catalyst (D); and
0.5% to 30% of an additive chosen from plasticizers, solvents, pigments, adhesion promoters, moisture absorbers, UV stabilizers, rheological agents and fillers other than the carbonate fillers.

23. The sealant composition as claimed in claim 13, wherein the sealant comprises from:
20% to 30% by weight of polymer (A) comprising an alkoxysilane group;
40% to 60% by weight of carbonate filler (B);
0.5% to 1.5% by weight of polysiloxane resin (C);
0.2% to 0.8% by weight of crosslinking catalyst (D); and
10% to 30% of an additive chosen from plasticizers, solvents, pigments, adhesion promoters, moisture absorbers, UV stabilizers, rheological agents and fillers other than the carbonate fillers.

24. An adhesive, sealant or coating comprising the composition as defined in claim 13.
